(19) United States
(12) Patent Application Publication
(10) Pub. No.: US 2026/0223033 A1
(43) Pub. Date: Jul. 30, 2026

(54) INBOUND ROAMING SUBSCRIPTION TRACKING FOR WIRELESS NETWORKS

(71) Applicant: T-MOBILE INNOVATIONS LLC, Overland Park, KS (US)

(72) Inventor: Romil Kumar Sood, Bothell, WA (US)

(21) Appl. No.: 19/037,865

(22) Filed: Jan. 27, 2025

(51) Int. Cl. H04W 60/04; H04W 8/18; H04W 84/04

(52) U.S. Cl. CPC H04W 60/04; H04W 8/183; H04W 84/042

(57) ABSTRACT

Systems, methods, and software are disclosed herein for detecting and monitoring changes in subscription status of UEs registering for services of wireless communication networks in various implementations. In one example, a method of operating a wireless network comprises maintaining a database of roaming devices previously registered with the wireless network. During a visit by a UE to the wireless network, receiving a registration request for the UE is received and the database of roaming registrations is searched for a previous registration by the UE. The registration request is then processed based on the previous registration by the UE.

### TECHNICAL FIELD

Aspects of the disclosure are related to the field of device registration in wireless communication networks.

### BACKGROUND

Interoperating arrangements in wireless communications can take the form of partnerships between two wireless networks (e.g., for services such as roaming) or agreements with third-party operators, such as Mobile Virtual Network Operators (MVNOs), to provide network access and service delivery on a wholesale basis. Roaming agreements between wireless communication networks enable extended service coverage for subscribers while providing an additional source of revenue for operators. These agreements allow networks to monetize their infrastructure by offering access to visiting subscribers from partner networks, generating income through usage-based billing and revenue-sharing mechanisms.

Similarly, business arrangements between wireless communication networks and third-party providers such as MVNOs enable the third-party providers to offer wireless services without owning physical network infrastructure. Under these agreements, the wireless network operator provides access to its network resources, including spectrum, radio access, and core network capabilities according to service-level agreements that define quality of service (QoS), operational support, and compliance with regulatory requirements.

Beyond connectivity, interoperating agreements between wireless networks and between networks and third-party providers often include provisions for QoS management, data privacy, and regulatory compliance, making them a strategic asset for maximizing network utilization and profitability. These interoperating agreements ensure that users can seamlessly access a wireless network, whether as a native subscriber, a roaming user, or an MVNO subscriber, providing flexibility and continuity of service across diverse scenarios.

### OVERVIEW

Technology is disclosed herein for detecting and monitoring changes in subscription status of user equipment registering for services of wireless communication networks in various implementations. In one example, a method of operating a wireless network comprises allowing roaming devices to register with the wireless network and maintaining a database of roaming devices previously registered with the wireless network. The method further comprises, during a visit by a user equipment (UE) to the wireless network, receiving a registration request for the UE; searching the database of roaming registrations for a previous registration by the UE; and processing the registration request based on the previous registration by the UE.

In another example, a computing apparatus comprises one or more computer readable storage media, one or more processors operatively coupled with the one or more computer readable storage media and program instructions stored on the one or more computer readable storage media that, when executed by the one or more processors, direct the computing apparatus to maintain a database of roaming devices previously registered with the wireless network; during a visit by a UE to the wireless network, receive a registration request for the UE; search the database of roaming registrations for a previous registration by the UE; and process the registration request based on the previous registration by the UE.

In yet another example of the technology disclosed herein, one or more computer readable storage media having program instructions stored thereon that, when executed by one or more processors, direct a computing apparatus to maintain a database of roaming devices previously registered with the wireless network; during a visit by a UE to the wireless network, receive a registration request for the UE; search the database of roaming registrations for a previous registration by the UE; and process the registration request based on the previous registration by the UE.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment for detecting and monitoring changes to subscription status of UEs in an implementation.

FIG. 2 illustrates a method of detecting and monitoring changes to subscription status of UEs in an implementation.

FIG. 3 illustrates an operational environment for detecting and monitoring changes to subscription status of UEs in an implementation.

FIG. 4 illustrates a workflow for detecting and monitoring changes to subscription status of UEs in an implementation.

FIG. 5 illustrates an operational architecture of a wireless communication network in an implementation.

FIG. 6 illustrates an operational architecture for a wireless communication network in an implementation.

FIG. 7 illustrates a computing system suitable for implementing the various operational environments, architectures, processes, scenarios, and sequences discussed below with respect to the other Figures.

### DETAILED DESCRIPTION

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

Various implementations are disclosed herein for detecting scenarios in a wireless communication network where inbound roaming UEs subscribed to a partner of the host network by virtue of a roaming agreement are detected in a subsequent visit as accessing the network as subscribers of a mobile virtual network operator (MVNO). For example, the user of the roaming UE may purchase a “travel SIM” (travel Subscriber Identification Module) or eSIM (embedded SIM) of an MVNO for access to the host network in lieu of access as a roamer. Because the revenue to the host network that is generated from the MVNO access may be lower than that generated from access by the roaming agreement, this change or switch in the manner of access can impact the revenue streams of the host network. The impact on revenue will of course depend on the volume of roaming users who switch to network access via an MVNO.

To determine the magnitude of the impact to revenue arising from these switching scenarios, the technology disclosed herein provides systems, methods, and devices to detect when, on a host network, an inbound roaming UE (i.e., a roaming UE which is inbound with respect to the host network) has switched from roaming status (i.e., access as a UE of a roaming partner) to local subscription status (i.e., access as a UE of a partner MVNO). Moreover, detecting the switching behavior may be used to determine if, for example, the MVNO is selling access to the network to users in violation of their agreement with the host network. In addition to using such metrics to negotiate and monitor compliance with access policies and commercial agreements between a wireless network, its roaming partner, and its partner MVNOs, the information may also be used for detecting suspicious behavior and identifying potential security breaches, e.g., stolen device detection, identity theft detection, network security protection, and the like.

In an implementation of the technology disclosed herein, when a roaming UE accesses a host network (e.g., a network to which the UE is not natively subscribed), the host network tracks and records information including device and subscriber identifiers in a database of roaming UE registrations. When the roaming UE accesses the host network a second time having switched to an MVNO of the home network, the host network searches the database of roaming UE registrations for the device identifier of the roaming UE to determine that the roaming UE switched from a roaming status to a local or MVNO subscription status. The host network tracks switching scenarios to determine inbound roaming metrics such as the frequency of status switches with respect to a particular partner network, the frequency of status switches with respect to a particular MVNO, and changes in revenue projections associated with switching registrations. The host network may also identify switching behavior of a UE to initiate heightened monitoring of the device should the switching behavior exhibit a pattern of activity which has been correlated to malicious activity.

Technical effects of the technology disclosed herein include the ability to determine possible revenue leaks or losses arising from roaming UEs switching from a roaming status to a local subscription status. In particular, the disclosed technology enables real-time monitoring and analysis of UE status changes, allowing network operators to identify instances where roaming agreements or billing arrangements are bypassed. This capability enhances revenue assurance by providing actionable insights into anomalies, ensuring accurate billing for services rendered, and maintaining compliance with inter-operator agreements. Additionally, by leveraging predictive analytics, the system can forecast potential revenue impacts and suggest remedial actions to mitigate losses, ultimately improving overall network profitability and operational efficiency.

In addition to providing enhanced capacity for projecting the impact to revenue, advanced analytics and machine learning algorithms applied to detecting registration changes (i.e., changes to the UE’s subscription) can identify patterns indicative of fraud, such as SIM cloning, unauthorized network access, or abnormal usage behavior. By addressing such challenges, the technology ensures accurate revenue tracking, strengthens network security, and helps maintain the integrity of billing systems while fostering trust between operators and subscribers.

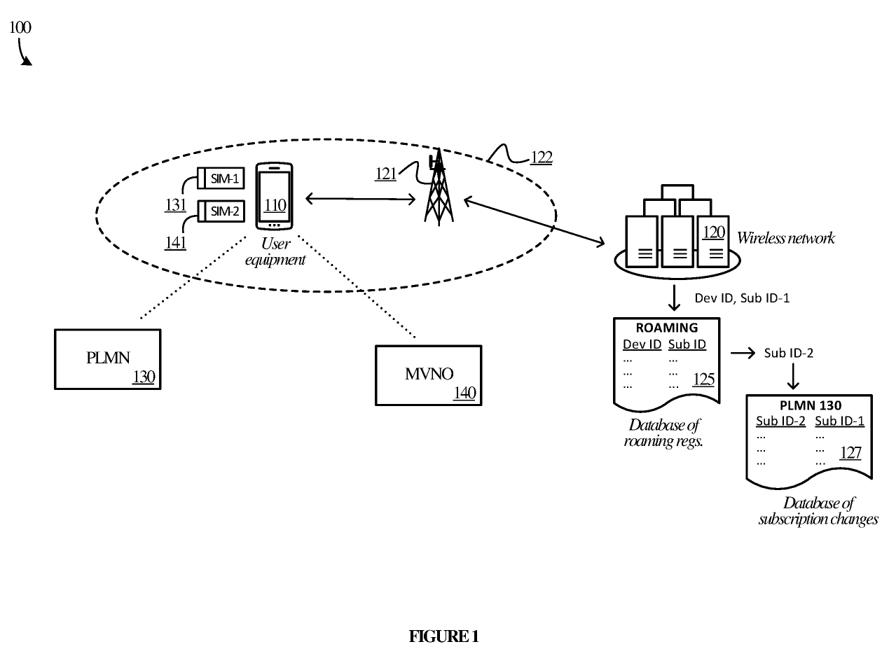

Turning now to the Figures, FIG. 1 illustrates operational environment 100 for detection and monitoring of changes in subscription status of inbound roaming UEs of wireless communication networks in an implementation. Operational environment 100 includes UE 110, wireless network 120, PLMN 130, and mobile virtual network operator (MVNO) 140. Operational environment 100 also includes access node 121, coverage area 122, roaming registration database 125, subscription change database 127, subscriber authentication module 131, and embedded subscriber authentication module 141.

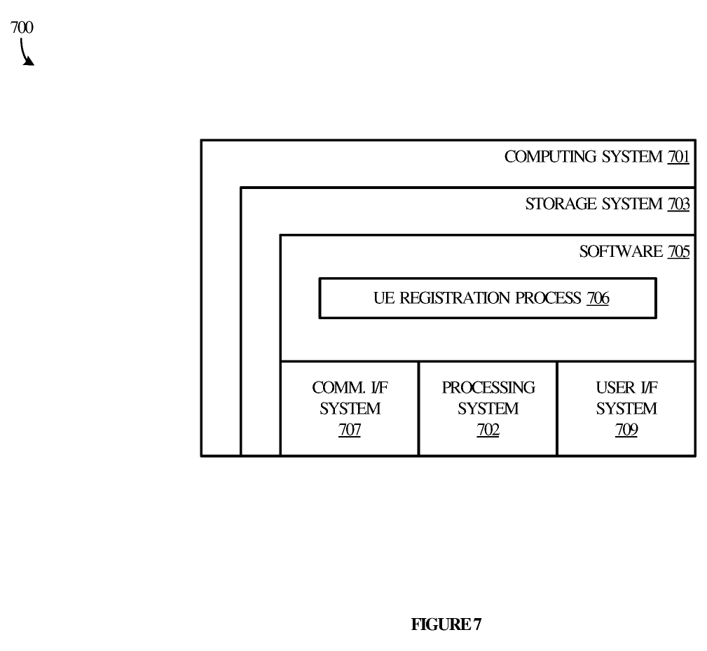

UE 110 is representative of a device, such as a smartphone, computer, sensor, controller, radio, and/or some other user apparatus, with processing circuitry for wireless communication with wireless network 120 using protocols such as Fifth Generation New Radio (5GNR), 5G Advanced, LTE, 6G, Institute of Electrical and Electronic Engineers (IEEE) 802.11 (Wifi), Low-Power Wide Area Network (LP-WAN), Near-Field Communications (NFC), Code Division Multiple Access (CDMA), Frequency Division Multiple Access (FDMA), and Time Division Multiple Access (TDMA). UE 110 can include devices such as Internet of Things (IoT) devices, wearable devices, smart vehicles, robots, sensors, augmented or virtual reality devices, and the like, such as a laptop or desktop computer, or mobile computing device, such as a tablet computer or cellular phone, of which computing system 701 in FIG. 7 is broadly representative. UE 110 exchanges wireless communication signals with access nodes of wireless network 120, such as access node 121 of wireless network 120, over radio frequency bands.

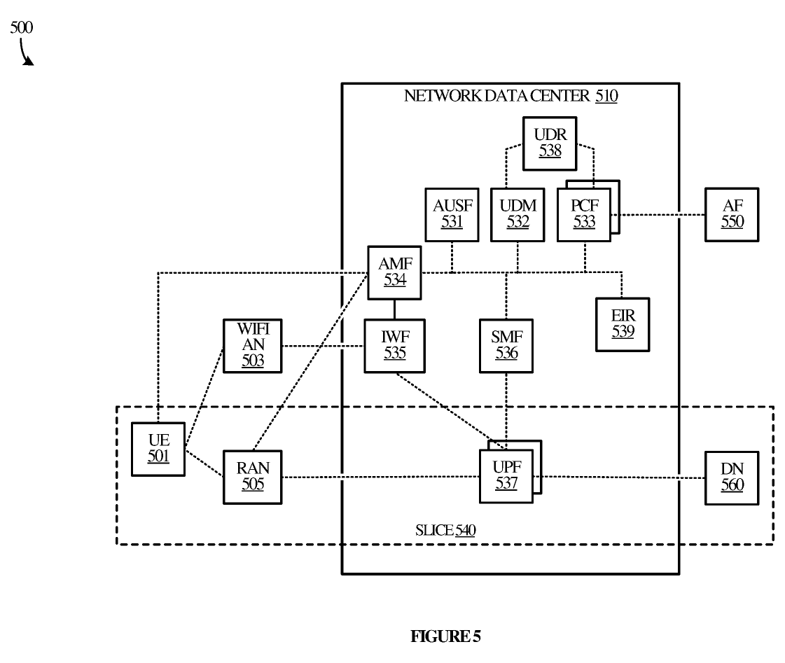

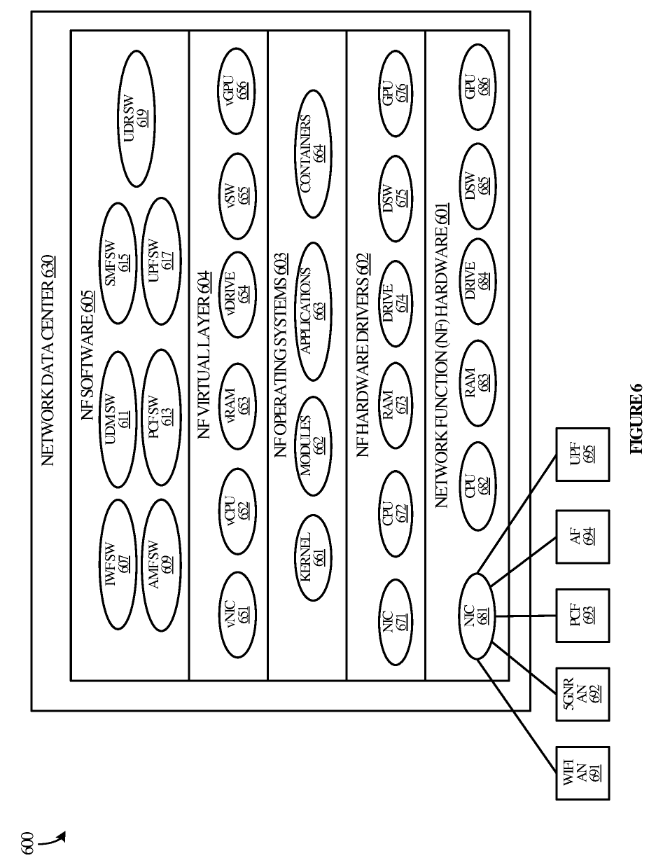

Wireless network 120 is representative of a communication network capable of using a Fifth Generation New Radio (5G-NR), LTE, 6G, or other protocol to communicate with computing devices such as UE 110. In an implementation, wireless network 120 is representative of a service-based architecture (SBA) which includes network functions which constitute the control plane and user plane of a wireless communication network core, of which network data center 510 of FIG. 5 and network data center 630 of FIG. 6 are representative. The network functions of wireless network 120 are implemented on one or more suitable computing devices, of which computing device 701 of FIG. 7 is representative. Examples of suitable computing devices include server computers, blade servers, and the like. The network elements of wireless network 120 may be implemented in the context of one or more data centers in a co-located or distributed manner, or in some other arrangement.

Access node 121 is representative of equipment, such as access nodes of Fifth Generation (5G) radio access networks (RANs), access nodes of long-term evolution (LTE) RANs, gNodeBs, eNodeBs, macrocells, NB-IoT access nodes, LP-WAN base stations, wireless relays, WiFi access nodes, and/or other wireless or wireline network transceivers. Access node 121 hosts access networks using radio frequencies to provide wireless network connectivity to devices such as UE 110. To communicate with a network core of wireless network 120, cells or base stations such as access node 121 include receiving unit (RU) circuitry which communicates along fronthaul data paths to distributed unit (DU) circuitry which in turn communicates with central unit (CU) circuitry along midhaul data paths. Although illustrated as a tower, access node 121 may include other physical configurations, including rooftop installations, small-cell sites, distributed antenna systems, vehicle-mounted systems, airborne access nodes, and so on.

Coverage area 122 is representative of a coverage area for wireless communication (e.g., cellular service) broadcast by an access node of a wireless communication network, such as access node 121 of wireless network 120.

Roaming registration database 125 is representative of a datastore of a wireless network 120 for tracking device registrations of UEs visiting the network. Roaming registration database 125 may be hosted by a network function such as a subscriber database function or equipment identity registration function of wireless network 120. In some cases, roaming registration database 125 may be hosted by a dedicated roaming orchestration or tracking function of wireless network 120. In any case, roaming registration database 125 may include records of inbound roaming UEs registering with wireless network 120 for access to network services. The records stored by roaming registration database 125 may include subscriber or device identifiers such as an International Mobile Subscriber Identity (IMSI), Mobile Station International Subscriber Directory Number (MSISDN), International Mobile Equipment Identity (IMEI), and identity of the (partner) network associated with the IMSI. The IMSI information may be obtained from a Subscriber Identification Module (SIM) card or embedded SIM (eSIM) of UE 110.

Subscription change database 127 is representative of a datastore of wireless network 120 for tracking changes in subscription status of roaming UEs accessing wireless network 120. Subscription change database 127 may be hosted by a network function such as a subscriber database function or equipment identity registration function of wireless network 120 or by a dedicated switching status tracking function of wireless network 120. Subscription change database 127 may include records of inbound roaming UEs registering with wireless network 120 for access to network services. The records stored by subscription change database 127 may include various subscriber or device identifiers such as an International Mobile Subscriber Identity (IMSI), a Mobile Station International Subscriber Directory Number (MSISDN), an International Mobile Equipment Identity (IMEI), and the identity of the (partner) network associated with the SIM or eSIM. The records stored by subscription change database 127 may also include contextual information, such as the time and location of the current and previous registrations or registration requests, so that data may be analyzed for suspicious activity.

PLMN 130 is representative of a Public Land Mobile Network which provides wireless communication services to subscriber devices or UEs such as UE 110 through its own licensed spectrum and network infrastructure. When a subscriber device of PLMN 130 is located outside the coverage area of PLMN 130, it roams onto a visited or host wireless network, such as wireless network 120, establishing connectivity in accordance with a roaming or partnering agreement between PLMN 130 and the host network operator.

Subscriber authentication modules 131 and 141 are representative of a device identifier or credential, such as a SIM card or eSIM, of a UE for securely identifying and authenticating a subscriber to a wireless network. Subscriber authentication modules 131 and 141 may include information, such as an IMSI, authentication keys, and network-specific data, that allows a UE to establish and maintain connectivity with a network. Subscriber authentication modules 131 and 141 facilitate authentication with the home network's authentication center and supports encryption to protect the integrity and confidentiality of user communications. Additionally, subscriber authentication modules 131 and 141 may store user-specific data, such as contact information, SMS, and configuration profiles, enabling personalized and seamless network access across different devices and regions. Unlike traditional removable SIM cards, an eSIM (also known as a “travel SIM” or “travel eSIM”) is integrated directly into the device's hardware and supports remote provisioning, allowing network credentials to be downloaded and managed over the air. eSIMs enable the UE to authenticate with the home or visited network, facilitating seamless connectivity and supporting features such as multi-network access, easier switching between operators, and enhanced security through tamper-resistant hardware.

Mobile virtual network operator (MVNO) 140 is representative of a third-party or virtual network operator which provides wireless communication services to subscriber devices or UEs such as UE 110 via the wireless network infrastructure of a host network operator such as wireless network 120. MVNO 140 provides wireless communication services to its subscribers on the basis of agreements with the host network operator to access host operator’s physical network resources, such as radio access networks (RAN) and core network components; on the basis of such agreements, subscribers of MVNO 140 may have a “local subscription status” with respect to the host network operator. MVNO 140 facilitates connectivity for UEs by leveraging the host network operator's infrastructure while managing its own subscriber policies, billing systems, and value-added services.

In a brief operational scenario of operational environment 100, UE 110, a subscriber device of PLMN 130, is in coverage area 122 (and thus outside of a coverage area of PLMN 130) roams onto wireless network 120. To register with wireless network 120, UE 110 provides subscriber authentication module 131 by which wireless network 120 identifies UE 110 as a subscriber of PLMN 130 and authenticates UE 110 for access to network services. When registering UE 110 as an inbound roaming device on the network, wireless network 120 records information relating to the visit in roaming registration database 125 including device credentials such as the IMSI, the IMEI, and the identity of the partner, i.e., PLMN 130.

Sometime after the initial visit to and registration with wireless network 120, UE 110 obtains subscriber authentication module 141 associated with MVNO 140 for access to network services of wireless network 120. UE 110 registers a second time for access to wireless network 120 but now provides subscriber authentication module 141 for authentication. When registering UE 110 as an inbound roaming device on the network, wireless network 120 identifies UE 110 as having a local subscription status and searches roaming registration database 125 to determine whether UE 110 has previously registered as an inbound roaming device. By searching roaming registration database 125 according to a device credential of UE 110 (“Dev ID”) such as the device IMEI, wireless network 120 determines that UE 110 previously visited the network as a subscriber to roaming partner PLMN 130 and has now switched its subscription status to a local subscription status associated with MVNO 140. Upon detecting that UE 110 has switched from a roaming status as a subscriber of PLMN 130 to a local subscription status as a subscriber of MVNO 140, wireless network 120 records parameters relating to the switch in subscription change database 127, such as the current subscriber identifier (“Sub ID-1”) and the previous subscriber identifier ("Sub ID-2”).

To determine the impact of switching, i.e., the updated subscription status, metrics may be computed based on information compiled in subscription change database 127. For example, switching metrics may be computed which reflect, for each partner network or PLMN, the number of inbound roaming UEs who switched to a local subscription status relative to the total number of inbound roaming UEs. Similar switching metrics may also be computed for each virtual provider network. In some scenarios, other kinds of switching may be compiled based on the information in subscription change database 127, such as the number of UEs with a local subscription status who switched to a roaming status.

In any case, the metrics computed based on subscription change database 127 may be used to derive the impact of switching to revenue with respect to PLMN 130 and MVNO 140. Such information may also be used to evaluate commercial agreements. In some cases, other information may be captured when a UE is identified as having switched subscription status. For example, the time between the previous registration and the subsequent registration as well as the geographic locations of the registrations may be used to identify patterns of behavior associated with malicious behavior such as device or identity theft. When switching behavior is identified, the wireless network may initiate an action such as adding a flag for heightened monitoring of the UE to a record of the UE in a subscriber database such as a Home Subscriber Server (HSS) or Uniform Data Repository (UDR) of the wireless network.

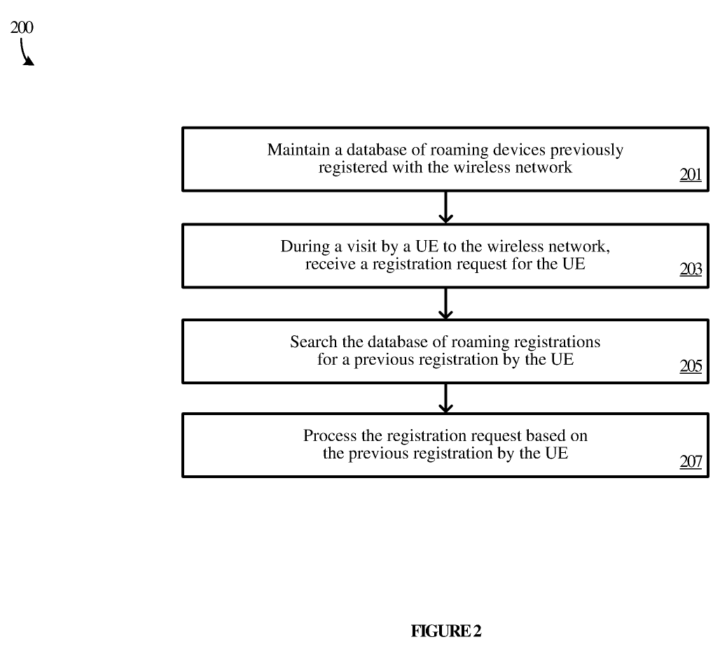

FIG. 2 illustrates a method of detecting and monitoring changes in subscription status of inbound roaming UEs of wireless communication networks in an implementation, herein referred to as process 200. Process 200 may be implemented in program instructions in the context of any of the software applications, modules, components, or other such elements of one or more computing devices. The program instructions direct the computing device(s) to operate as follows, referred to in the singular for the sake of clarity.

The computing device allows roaming devices to register with the wireless network. In an implementation, roaming devices such as smartphones or other UEs register with the wireless network as native subscribers or as inbound roamers for which the wireless network is a “visited” or “host” network. The inbound roamers may be subscribers of a partner network of the wireless network, registering with the wireless network on the basis of an inter-operational agreement between the networks. In some cases, the inbound roamers may register with the host network having obtained a subscription with an MVNO of a partner network.

As process 200 proceeds, the computing device maintains a database of roaming devices previously registered with the wireless network (step 201). In an implementation, the wireless network maintains a database of roaming device registrations which have registered with the wireless network. When the roaming UE connects to the home network infrastructure, a network functionality hosting the database records parameters relating to the device registration in the database. The database may include registration information such as a device identifier (e.g., an IMEI) of the roaming device, a subscriber identifier (e.g., and IMSI) of the roaming device, and an MSISDN of the roaming device. Other information may be captured or derived, such as the home network of the roaming device which may be determined based on the IMSI and the time and location of the registration. The database may be hosted by a network function such as a subscriber database (e.g., HSS, UDR) or an equipment registry (e.g., Equipment Identity Repository or EIR) of the wireless network. In some cases, the database may be hosted by a dedicated functionality such as a roaming registration tracking or orchestration function.

In an implementation, when a roaming UE enters the coverage of the wireless network that is not its home network (a host network) and seeks network service (e.g., IMS service) from the host network, it connects to the host network's infrastructure through a roaming agreement between the home network operator and the host network operator. The host network identifies the roaming UE using its IMSI or other subscriber identifier stored in the roaming UE's SIM or eSIM. The subscriber identifier is relayed to the home network for authentication and authorization via the authentication center. Once authenticated, the home network provides the host network with the roaming UE's subscription information, including permitted services and billing details, through protocols such as Diameter or SS7. The host network then allows the roaming UE to access network services like voice, data, or SMS. When the roaming UE registers with the network, the network function maintaining the database records information relating to the registration so that the registration can be identified based on the roaming UE’s IMEI.

During a visit by a UE to the wireless network, the computing device receives a registration request for the UE (step 203). In an implementation, when a UE of an MVNO registers with a wireless host network for the first time, the UE transmits its unique identifier, such as the IMSI, stored in its SIM or eSIM. The MVNO, which relies on a host network operator for infrastructure, initiates the registration process through the host network. The host network's systems, including the Diameter Routing Agent (DRA), receive the registration request and route it to the appropriate authentication entities. The Equipment Identity Register (EIR) of the host network also validates the device's IMEI to ensure it is not blacklisted or associated with fraudulent activity.

After the DRA routes the IMSI to the MVNO’s core network systems, the MVNO authenticates the UE using its authentication center and verifies the subscriber's profile stored in the HSS or equivalent database. Upon successful authentication, the MVNO communicates the subscriber's permitted services and Quality of Service (QoS) parameters to the host network. The host network, guided by the information from the DRA and EIR, enables connectivity while ensuring security and compliance with both MVNO and network operator policies. Having successfully attached to the host network, the UE can access network services, with data usage, voice calls, and SMS managed through the host network but billed according to the MVNO's policies.

During the process of enabling connectivity with the wireless network, the wireless network may ascertain that the registration request is a first request for the subscription. For example, the wireless network may determine from the IMSI that is associated with the MVNO the registration is the first time that the device is requesting access to the network as an MVNO subscriber. For example, a wireless network can determine that a UE subscribed to an MVNO is registering for network access for the first time by checking for the absence of prior registration records for the UE’s IMSI or IMEI in its databases, or by querying the MVNO’s HSS to confirm if the IMSI has been previously provisioned. During the registration process, the network may also validate the device’s IMEI against its EIR and detect whether the combination of IMSI and IMEI is new. Additionally, the MVNO’s systems may trigger a provisioning workflow if the IMSI has not been activated on the host network. First-time registration can also be identified through tracking network attachment events or detecting initial authentication states that include default or initialization parameters.

The computing device searches the database of roaming registrations for a previous registration by the roaming UE (step 205). In an implementation, when the UE attaches to the wireless network for the first time, the wireless network consults the database of roaming registrations to determine if there is a record of a previous registration of the UE. The search is triggered by determining that the registration request is for a first registration by a device subscribed to an MVNO according to the device IMSI. To search the database of roaming registrations, in an implementation, the wireless network searches the database for the IMEI of the UE. If a record of a previous registration is found, the IMSI of the UE is correlated to the IMSI stored in the record. The search may be initiated when the EIR of the wireless network receives registration information (e.g., device and subscription identifiers) for the UE from an HSS by monitoring data traffic between the HSS and EIR. The search may also be initiated when the HSS receives the registration information.

The computing device processes the registration request based on the previous registration by the UE (step 207). In an implementation, to process the registration request having correlated the request to a previous registration, the wireless network may record the parameters of the correlation in a database of registration changes. The parameters may include the device and subscriber identifiers (e.g., the correlated IMSIs, the IMEI, the MSISDN), the home network of the UE from the previous registration. Contextual information of the previous and current registrations may also be recorded, such as times and geographic locations of the registrations.

Having identified that the UE has switched from a roaming registration to a local subscription registration (i.e., registration via an MVNO of the host network), processing the registration request can also include generating metrics relating to the frequency with which subscribers of the home network are switching to a subscription to an MVNO of the host network for access to the network. Because switching registrations can result in a reduction in revenue, switching frequency can be an important metric in negotiating partnering agreements with other networks. Moreover, as the data is recorded, should the switching frequency associated with a given home (partner) network exceed a threshold value, this may trigger other actions such as generating a report of the switching scenarios including, for a given home network, a percentage of roaming UEs who switched to a local subscription of an MVNO with respect to all roaming UEs of the home network. Processing the registration request, particularly amongst multiple such switching scenarios occurring within a given period of time, may also trigger other actions such as rebalancing network resources to accommodate the increase in switching.

Processing the registration request can also include identifying switching behavior associated with malicious activity such as device theft, identity theft, or network security breaches. For example, a machine learning model (e.g., an artificial neural network) may be trained to identify malicious behaviors that are correlated to records of switched registrations. When switching behavior is identified by the trained model as suspicious, e.g., as having a higher likelihood of being associated with malicious activity, the UE may be flagged for a higher level of scrutiny. For example, a record of the UE in a subscriber database of the network (e.g., an HSS) may be flagged for monitoring. In some scenarios, the UE may be prevented from accessing the network.

Referring again to FIG. 1, a brief example of process 200 as employed by elements of operational environment 100 follows. In operation, wireless network 120 allows roaming UEs to register for access to network services (e.g., phone, data, SMS services) according to operational agreements with partner networks. Wireless network 120 maintains roaming registration database 125 including historical data of registrations by the roaming UEs such as the device and subscriber identifiers. Roaming registration database 125 may also include other information such as the time of location of the previous registration requests.

Wireless network 120 receives a registration request from UE 110 which has roamed into coverage area 122. The registration request indicates that UE 110 is registering for the first time with wireless network 120 as a subscriber of MVNO 140. Wireless network 120 searches roaming registration database 125 for any previous registration by UE 110 as a roaming UE. When a previous registration is found, wireless network 120 processes the registration request based on the correlation to the previous registration. Processing the request can include recording information relating to the correlation in subscription change database 127. Processing can also include generating and reporting metrics which reflect a frequency of roaming UEs switching to an MVNO subscription for access to wireless network 120. Processing can also include analyzing the current registration and the previous registration for suspicious behavior and instituting a higher level of monitoring of UE 110, such as flagging records of UE 110 in various databases (e.g., an HSS) of wireless network 120 for additional scrutiny, for limiting or blocking access to the network, and so on.

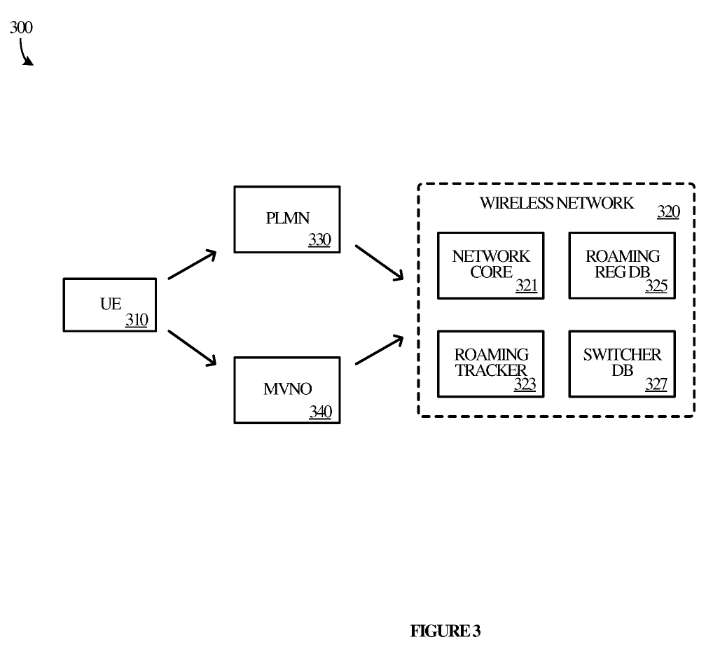

Turning now to FIG. 3, FIG. 3 illustrates operational environment 300 for detection and monitoring of changes in subscription status of inbound roaming UEs of wireless communication networks in an implementation. Operational environment 300 includes wireless network 320 including network core 321, roaming tracker 323, roaming registration database 325, and switching database 327. Operational environment 300 also includes UE 310, PLMN 330, and MVNO 340.

UE 310 is representative of a device, such as a smartphone, computer, sensor, controller, radio, and/or some other user apparatus, with processing circuitry for wireless communication with wireless network 320 using protocols such as Fifth Generation New Radio (5GNR), 5G Advanced, LTE, 6G, Institute of Electrical and Electronic Engineers (IEEE) 802.11 (Wifi), Low-Power Wide Area Network (LP-WAN), Near-Field Communications (NFC), Code Division Multiple Access (CDMA), Frequency Division Multiple Access (FDMA), and Time Division Multiple Access (TDMA). UE 310 can include devices such as Internet of Things (IoT) devices, wearable devices, smart vehicles, robots, sensors, augmented or virtual reality devices, and the like, such as a laptop or desktop computer, or mobile computing device, such as a tablet computer or cellular phone, of which computing system 701 in FIG. 7 is broadly representative. UE 310 exchanges wireless communication signals with access nodes of wireless network 320 over radio frequency bands.

Wireless network 320 is representative of a communication network capable of using a Fifth Generation New Radio (5G-NR), LTE, 6G, or other protocol to communicate with computing devices such as user equipment 310. In an implementation, wireless network 320 is representative of a service-based architecture (SBA) which includes network functions which constitute the control plane and user plane of network core 321, of which network data center 510 of FIG. 5 and network data center 630 of FIG. 6 are representative. The network functions of wireless network 320, such as roaming tracker 323, are implemented on one or more suitable computing devices, of which computing device 701 of FIG. 7 is representative. Examples of suitable computing devices include server computers, blade servers, and the like. The network elements of wireless network 320 may be implemented in the context of one or more data centers in a co-located or distributed manner, or in some other arrangement.

Wireless network 320 includes roaming tracker 323, a network functionality implemented in software or hardware for maintaining roaming registration database 325. Roaming tracker 323 receives registration information for UEs roaming on wireless network 320. The registration information may include device and subscriber identifiers (e.g., IMSI, IMEI, MSISDN) as well as contextual information (e.g., time and location) of the roaming UE submitting the registration request.

Roaming registration database 325 is representative of a datastore, such as a database, log, or registry, of a wireless network 320 for tracking device registrations of UEs visiting the network. Roaming registration database 325 may be hosted by a network function such as roaming tracker 323. Roaming registration database 325 may include records of inbound roaming UEs registering with wireless network 320 for access to network services. The records stored by roaming registration database 325 may include subscriber or device identifiers such as an IMSI, MSISDN, IMEI, and identity of the (partner) network associated with the IMSI. The IMSI information may be obtained from a SIM card or eSIM of UE 310.

Switching database 327 is representative of a datastore (e.g., database, log, registry) of wireless network 320 for logging modifications to the roaming or subscription status of UEs roaming on wireless network 320. Switching database 327 may be hosted by a network function such as a subscriber database function or equipment identity registration function of wireless network 320 or by a dedicated switching status tracking function of wireless network 320. Switching database 327 may include records of inbound roaming UEs registering with wireless network 320 for access to network services. The records stored by switching database 327 may include various subscriber or device identifiers such as an IMSI, MSISDN, IMEI, and identity of the network associated with the SIM or eSIM. The records stored by switching database 327 may also include contextual information, such as the time and location of the current and previous registrations or registration requests, so that data may be analyzed for suspicious activity.

PLMN 330 is representative of a Public Land Mobile Network which provides wireless communication services to subscriber devices or UEs such as UE 310 through its own licensed spectrum and network infrastructure. When a subscriber device of PLMN 330 is located outside the coverage area of PLMN 330, it roams onto a host wireless network, such as wireless network 320, establishing connectivity in accordance with a roaming or partnering agreement between PLMN 330 and the host network operator.

MVNO 340 is representative of a third-party or virtual network operator which provides wireless communication services to subscriber devices or UEs such as UE 310 via the wireless network infrastructure of a host network operator such as wireless network 320. MVNO 340 provides wireless communication services to its subscribers on the basis of agreements with the host network operator to access host operator’s physical network resources, such as RAN and core network components; on the basis of such agreements, subscribers of MVNO 340 may have a local or MVNO subscription status with respect to the host network operator. MVNO 340 facilitates connectivity for UEs by leveraging the host network operator's infrastructure while managing its own subscriber policies, billing systems, and value-added services.

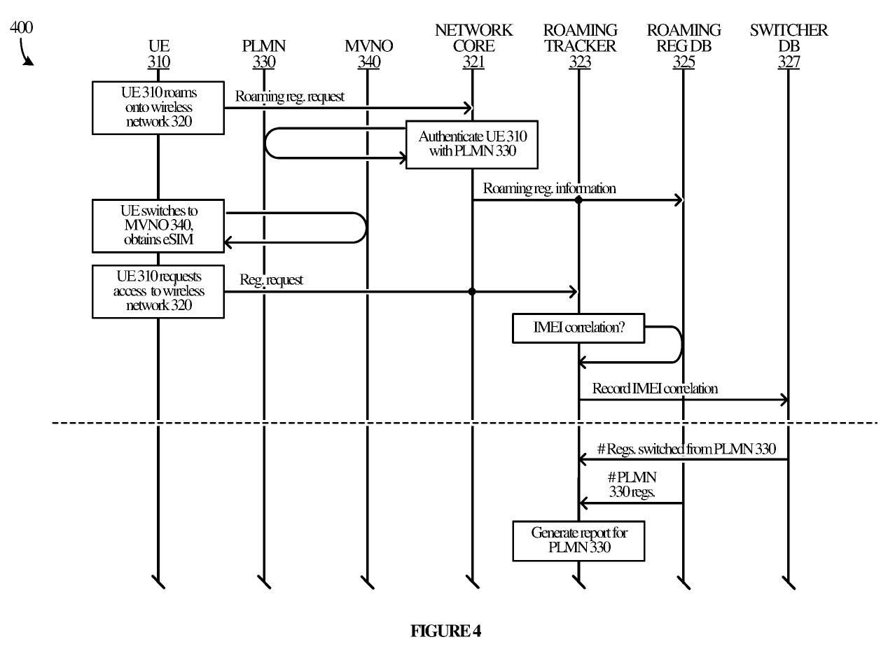

FIG. 4 illustrates workflow 400 for detecting and monitoring changes in the subscription status of inbound roaming UEs of wireless communication networks in an implementation, referring to elements of operational environment 300.

In workflow 400, UE 310 enters the coverage area of wireless network 320 and requests access to the network. UE 310 submits at least its IMEI and IMSI by which wireless network 320 determines the home network of UE 310—PLMN 330. Network core 321 authenticates UE 310 through PLMN 330 and registers UE 310 for network service. Network core 321 also provides the roaming registration information to roaming tracker 323 which records the information in roaming registration database 325. The registration information can include the device and subscriber identifiers, the MSISDN of UE 310, the identity of PLMN 330, and the time and location of the registration request.

At sometime subsequent to the roaming registration with wireless network 320, UE 310 subscribes to MVNO 340 and receives and eSIM from MVNO 340 with an IMSI associated with MVNO 340. UE 310 requests network service from wireless network 320; the request is the first request received from a device using the IMSI associated with MVNO 340. Wireless network 320 determines that the IMSI associated with MVNO 340 is new with respect to wireless network 320. Network core 321 processes the request to register UE 310 for service and, based on determining that the IMSI is new with respect to wireless network 320, prompts roaming tracker 323 to search for a previous registration by UE 310. Roaming tracker 323 searches roaming registration database 325 for a record matching the IMEI of UE 310 and identifies the previous registration of UE 310 having roamed onto wireless network 320 as a subscriber of PLMN 330. Thus, on the basis of the IMEI of UE 310, roaming tracker 323 correlates the IMSI of the previous registration with the IMSI of the current registration. Roaming tracker 323 records the correlation and associated information in switching database 327.

As other UEs register with wireless network 320 having switched subscription statuses, roaming tracker 323 continues to update switching database 327 with information relating to the subscription switching. Roaming tracker 323 computes metrics relating to the switching behaviors in relation to PLMN 330, such as the frequency of switching behavior by roaming UEs subscribed to PLMN 330. Roaming tracker 323 generates a report of the data, such as a period update or when the frequency exceeds a threshold. Roaming tracker 323 may also perform other actions in response to receiving the registration request and detecting the switching behavior of UE 310. For example, roaming tracker 323 may assess information about the switching behavior to determine whether switching behavior is unusual or warrants heightened monitoring. To assess the switching behavior, roaming tracker 323 may provide the information about the switching behavior to an AI model trained to identify whether the behavior correlates to malicious activity or to return a likelihood of being associated with malicious activity.

FIG. 5 illustrates exemplary wireless communication system 500 that serves wireless User Equipment (UE) 501. Wireless communication system 500 includes UE 501, WiFi Access Node (AN) 503, 5GNR RAN 505, Interworking Function (IWF) 535, Access and Mobility Management Function (AMF) 534, Authentication Server Function (AUSF) 531, Unified Data Management (UDM) 532, Policy Control Functions (PCFs) 533, Session Management Function (SMF) 536, User Plane Function (UPF) 537, Uniform Data Repository (UDR) 538, Equipment Identity Repository (EIR) 539, and Application Function (AF) 550. UDR 538 stores network data including subscriber profiles including identities, subscription details, service preferences, authentication credentials, and billing information. UDR 538 may also store policy data such as network rules, access rules, mobility rules, charging rules, and so on. In some scenarios, UDR 538 may also store a database of roaming registrations or a database of information relating to switching scenarios. AF 550 may provide policies applicable to control plane functions, that is, to the application, presentation, and/or session layers of the OSI protocol stack. IWF 535 includes non-3GPP IWFs (N3IWFs) for providing untrusted non-3GPP access to network data center 510, such as access via a non-cellular access network.

Continuing with wireless communication system 500, wireless network slice 540 includes UPF 537 and SMF 536. Wireless network slice 540 is representative of a dynamically allocated slice of finite duration selected for hosting service from DN 560 to UE 501 according to the technology disclosed herein, including process 200 or workflow 400. DN 560 is representative of a data network, Internet access, third-party resource, or other endpoint of an end-to-end communication path from UE 501.

In an implementation, UE 501 communicates with network data center 510 via 5G-NR access node 505 or WiFi access node 503. UE 501 requests access to DN 560 via the communication network of network data center 510, e.g., via wireless network slice 540. SMF 536 receives the access request from AMF 534 and other network functions of the communication network which are enforcing various aspects of the access request from UE 501. SMF 536 receives policies or policy decisions from AUSF 531, UDM 532, PCF 533, and/or AMF 534.

FIG. 6 illustrates exemplary network data center 630, a network core of a wireless communication system, of which wireless network 120 of FIG. 1 is representative. Network data center 630 includes network function (NF) software 605, network function virtual layer 604, network function operating systems 603, network function hardware drivers 602, and network function hardware 601.

Network function software 605 of network data center 630 includes software for executing various network functions: IWF software 607, AMF software 609, UDM software 611, PCF software 613, SMF software 615, UPF software 617, and UDR software 619. Other network function software, such as network repository function (NRF) software, are typically present but are omitted for clarity.

Network function virtual layer 604 includes virtualized components of network data center 630, such as virtual NIC 651, virtual CPU 652, virtual RAM 653, virtual drive 654, virtual software 655, and virtual GPU 656. Network operating systems 603 includes components for operating network data center 630, including kernels 661, modules 662, applications 663, and containers 664 for network function software execution. Network function hardware drivers 602 include software for operating network function hardware 601 of network data center 630, including network interface card (NIC) drivers 671 for network interface cards (NICs) 681, CPU drivers 672 for CPUs 682, RAM drivers 673 for RAM 683, flash/disk drive drivers 674 for flash/disk drives 684, data switch (DSW) drivers 675 for data switches 685, and drivers 676 for GPUs 686. Network interface cards 681 of network function hardware 601 include hardware components for communicating with WiFi access node 691, 5GNR access node 692, PCF 693, application server 694, and UPF 695.

FIG. 7 illustrates computing device 701 that is representative of any system or collection of systems in which the various processes, programs, services, and scenarios disclosed herein may be implemented. Examples of computing device 701 include, but are not limited to, desktop and laptop computers, tablet computers, mobile computers, and wearable devices. Examples may also include server computers, web servers, cloud computing platforms, and data center equipment, as well as any other type of physical or virtual server machine, container, and any variation or combination thereof.

Computing device 701 may be implemented as a single apparatus, system, or device or may be implemented in a distributed manner as multiple apparatuses, systems, or devices. Computing device 701 includes, but is not limited to, processing system 702, storage system 703, software 705, communication interface system 707, and user interface system 709 (optional). Processing system 702 is operatively coupled with storage system 703, communication interface system 707, and user interface system 709.

Processing system 702 loads and executes software 705 from storage system 703. Software 705 includes and implements UE registration process 706, which is (are) representative of the UE registration processes discussed with respect to the preceding Figures, such as process 200 and workflow 400. When executed by processing system 702, software 705 directs processing system 702 to operate as described herein for at least the various processes, operational scenarios, and sequences discussed in the foregoing implementations. Computing device 701 may optionally include additional devices, features, or functionality not discussed for purposes of brevity.

Referring still to FIG. 7, processing system 702 may comprise a micro-processor and other circuitry that retrieves and executes software 705 from storage system 703. Processing system 702 may be implemented within a single processing device but may also be distributed across multiple processing devices or sub-systems that cooperate in executing program instructions. Examples of processing system 702 include general purpose central processing units, graphical processing units, application specific processors, and logic devices, as well as any other type of processing device, combinations, or variations thereof.

Storage system 703 may comprise any computer readable storage media readable by processing system 702 and capable of storing software 705. Storage system 703 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 703 may also include computer readable communication media over which at least some of software 705 may be communicated internally or externally. Storage system 703 may be implemented as a single storage device but may also be implemented across multiple storage devices or sub-systems co-located or distributed relative to each other. Storage system 703 may comprise additional elements, such as a controller, capable of communicating with processing system 702 or possibly other systems.

Software 705 (including UE registration process 706) may be implemented in program instructions and among other functions may, when executed by processing system 702, direct processing system 702 to operate as described with respect to the various operational scenarios, sequences, and processes illustrated herein. For example, software 705 may include program instructions for implementing a UE registration process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 705 may include additional processes, programs, or components, such as operating system software, virtualization software, or other application software. Software 705 may also comprise firmware or some other form of machine-readable processing instructions executable by processing system 702.

In general, software 705 may, when loaded into processing system 702 and executed, transform a suitable apparatus, system, or device (of which computing device 701 is representative) overall from a general-purpose computing system into a special-purpose computing system customized to support UE registration processes including detection and monitoring in an optimized manner. Indeed, encoding software 705 on storage system 703 may transform the physical structure of storage system 703. The specific transformation of the physical structure may depend on various factors in different implementations of this description. Examples of such factors may include, but are not limited to, the technology used to implement the storage media of storage system 703 and whether the computer-storage media are characterized as primary or secondary storage, as well as other factors.

For example, if the computer readable storage media are implemented as semiconductor-based memory, software 705 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 707 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 701 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

Unless the context clearly requires otherwise, throughout the description and the claims, the words "comprise," "comprising," “such as,” and “the like” are to be construed in an inclusive sense, as opposed to an exclusive or exhaustive sense, that is to say, in the sense of "including, but not limited to.” As used herein, the terms "connected," "coupled," or any variant thereof means any connection or coupling, either direct or indirect, between two or more elements; the coupling or connection between the elements can be physical, logical, or a combination thereof. Additionally, the words "herein," "above," "below," and words of similar import, when used in this application, refer to this application as a whole and not to any particular portions of this application. Where the context permits, words in the above Detailed Description using the singular or plural number may also include the plural or singular number respectively. The word "or," in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having operations, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words "means for," but use of the term "for" in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A method of operating a wireless network comprising:
maintaining a database of roaming devices previously registered with the wireless network;
during a visit by a user equipment (UE) to the wireless network, receiving a registration request for the UE;
searching the database of roaming registrations for a previous registration by the UE; and
processing the registration request based on the previous registration by the UE.

2. The method of claim 1, wherein processing the registration request based on the previous registration by the UE comprises:
identifying a change in subscription status of the UE; and
storing parameters relating to the change in subscription status of the UE in a log of subscription changes.

3. The method of claim 2, wherein the parameters include a previous subscriber identifier of the previous registration, a roaming partner of the previous registration, and a subscriber identifier of the UE.

4. The method of claim 3, further comprising computing a metric relating to changes in subscription status of devices associated with the roaming partner of the previous registration based on the log of subscription changes.

5. The method of claim 1, wherein processing the registration request based on the previous registration by the UE comprises:
identifying a change in subscription status of the UE; and
adding a flag for heightened monitoring of the UE to a record of the UE in a subscriber database of the wireless network.

6. The method of claim 1, wherein searching the database of roaming registrations for the previous registration by the UE comprises correlating a subscriber identifier of the UE to a subscriber identifier of the previous registration by the UE according to a device identifier of the UE.

7. The method of claim 6, wherein a device identifier comprises an International Mobile Equipment Identity (IMEI) and wherein a subscriber identifier comprises an International Mobile Subscriber Identity (IMSI).

8. The method of claim 1, wherein searching the database of roaming registrations for a previous registration by the UE comprises searching the database of roaming registrations for a previous registration by the UE in response to receiving, by an equipment identity registry (EIR) of the wireless network, a device identifier of the UE.

9. A computing apparatus comprising:
one or more computer readable storage media;
one or more processors operatively coupled with the one or more computer readable storage media; and
program instructions stored on the one or more computer readable storage media that, when executed by the one or more processors, direct the computing apparatus to at least:
maintain a database of roaming devices previously registered with a wireless network;
during a visit by a user equipment (UE) to the wireless network, receive a registration request for the UE;
search the database of roaming registrations for a previous registration by the UE; and
process the registration request based on the previous registration by the UE.

10. The computing apparatus of claim 9, wherein to process the registration request based on the previous registration by the UE, the program instructions direct the computing apparatus to:
identify a change in subscription status for the UE; and
store parameters relating to the change in subscription status of the UE in a log of subscription changes.

11. The computing apparatus of claim 10, wherein the parameters include a previous subscriber identifier of the previous registration, a roaming partner of the previous registration, and a subscriber identifier of the UE.

12. The computing apparatus of claim 11, wherein the program instructions further direct the computing apparatus to compute a metric relating to changes in subscription status of devices associated with the roaming partner of the previous registration based on the log of subscription changes.

13. The computing apparatus of claim 9, wherein to process the registration request based on the previous registration by the UE, the program instructions direct the computing apparatus to:
identify a change in subscription status of the UE; and
add a flag for heightened monitoring of the UE to a record of the UE in a subscriber database of the wireless network.

14. The computing apparatus of claim 9, wherein to search the database of roaming registrations for the previous registration by the UE, the program instructions direct the computing apparatus to correlate a subscriber identifier of the UE to a subscriber identifier of the previous registration by the UE according to a device identifier of the UE.

15. The computing apparatus of claim 14, wherein a device identifier comprises an International Mobile Equipment Identity (IMEI) and wherein a subscriber identifier comprises an International Mobile Subscriber Identity (IMSI).

16. The computing apparatus of claim 9, wherein to search the database of roaming registrations for a previous registration by the UE, the program instructions direct the computing apparatus to search the database of roaming registrations for a previous registration by the UE in response to receiving, by an equipment identity registry (EIR) of the wireless network, a device identifier of the UE.

17. One or more computer readable storage media having program instructions stored thereon that, when executed by one or more processors, direct a computing apparatus to at least:
maintain a database of roaming devices previously registered with a wireless network;
during a visit by a user equipment (UE) to the wireless network, receive a registration request for the UE;
search the database of roaming registrations for a previous registration by the UE; and
process the registration request based on the previous registration by the UE.

18. The one or more computer readable storage media of claim 17, wherein to process the registration request based on the previous registration by the UE, the program instructions direct the computing apparatus to:
identify a change in subscription status for the UE; and
store parameters relating to the change in subscription status of the UE in a log of subscription changes.

19. The one or more computer readable storage media of claim 18, wherein the parameters include a previous subscriber identifier of the previous registration, a roaming partner of the previous registration, and a subscriber identifier of the UE.

20. The one or more computer readable storage media of claim 19, wherein the program instructions further direct the computing apparatus to compute a metric relating to changes in subscription status of devices associated with the roaming partner of the previous registration based on the log of subscription changes.
